(19) United States
(12) Patent Application Publication
(10) Pub. No.: US 2026/0328252 A1
(43) Pub. Date: Oct. 22, 2026

(54) CLUTCH ASSEMBLY

(71) Applicant: AUDI AG, Ingolstadt (DE)

(72) Inventor: Bastian GEBHARD, Beilngries (DE)

(73) Assignee: AUDI AG, Ingolstadt (DE)

(21) Appl. No.: 19/112,081

(22) PCT Filed: Sep. 11, 2023
(86) PCT No.: PCT/EP2023/074832

§ 371 Date: Mar. 14, 2025

(30) Foreign Application Priority Data
Sep. 15, 2022 (DE) 10 2022 123 602.1

(51) Int. Cl. F16D 11/14; F16D 23/14

(52) U.S. Cl. CPC F16D 11/14; F16D 23/14; F16D 2300/22

(57) ABSTRACT

In an example, a clutch assembly has two shaft portions, which can be coupled by a dog clutch, which has a sliding dog, which is arranged so as to be rotationally fixed but axially displaceable on one of the shaft portions. In operating state, for example, in a fault case, the sliding dog may be adjusted counter to the closing direction in a restoring movement (R). According to the example, a damping element, against which the sliding dog strikes during the restoring movement (R), may be provided to reduce kinetic energy, for example, shock energy.

### CROSS-REFERENCE TO RELATED APPLICATIONS

This application is a U.S. national stage of International Application No. PCT/EP2023/074832, filed on Sep. 11, 2023, which claims the priority benefit of German Patent Application No. 10 2022 123 602.1 filed on Sep. 15, 2022. Both the International Application and the German Patent Application are incorporated by reference herein in their entirety.

### BACKGROUND

### 1. Field

The examples of an invention in the present disclosure relate to a clutch assembly.

### 2. Description of the Related Art

A clutch assembly of the type in question has a first shaft portion and a second shaft portion, which can be coupled by a dog clutch. The dog clutch has a sliding dog, which is arranged so as to be rotationally fixed but axially displaceable on the first shaft portion. In addition, the dog clutch has a fixed dog, which interacts therewith and is arranged so as to be rotationally fixed and axially fixed in position on the second shaft portion.

A regular closing operation is carried out with a small speed difference between the two shaft portions, i.e. with the two shaft portions virtually synchronized, for example at 10 rpm. In such a regular closing operation, an actuator-operated sliding sleeve, through the intermediary of an overload spring, first of all brings the sliding dog in the axial direction into tooth to tooth contact with the fixed dog. Once the tooth to tooth contact has been achieved, the sliding sleeve is further adjusted into its closed position, specifically by building up an overload spring force that acts axially on the dogs. As soon as tooth to gap contact has been established in the case of a small rotational angle offset, the two dogs enter into positively locking connection, with the overload spring force being reduced.

In a fault case, in the case of an excessively large speed difference, the sliding sleeve can be incorrectly adjusted into its closed position by the actuator, while the sliding dog rebounds off deflection contours of the fixed dog. This results in the creation of axial dynamics, in the case of which the sliding dog rebounds off the deflection contours of the fixed dog axially counter to the closing direction in a restoring movement and then springs back again in the closing direction into the tooth to tooth contact, specifically with a shock being applied to the fixed dog (i.e. to its deflection contours). In the case of sufficiently high shock energy, the sliding dog can unintentionally (and in spite of the deflection contours) enter into positively locking connection with the fixed dog, which can impair the operational safety of the dog clutch.

DE 103 39 125 A1 discloses a sheet-like assembly for elastically absorbing shocks in a vehicle. DE 201 06 540 U1 discloses a spring and damping element with rubber granulate filling. DE 10 2008 040 508 A1 discloses a device for pressing a steering rack. EP 3 608 517 A1 discloses a damping device for a gas turbine engine. EP 3 708 491 A1 discloses a particle damped torque bar.

### SUMMARY

According to the described examples of the invention a clutch assembly is provided, the operational safety of which is enhanced in a straightforward manner compared to the prior art.

The described examples may be recited by the features of the present independent claims the dependent claims of the independent claims.

The examples of the present invention may proceed from a clutch assembly having a first shaft portion and a second shaft portion, which can be coupled by a dog clutch. The dog clutch has a sliding dog, which is arranged so as to be rotationally fixed but axially displaceable on one of the shaft portions. In a certain operating state, in particular a fault case, the sliding dog can be abruptly adjusted counter to the closing direction in a restoring movement. In an example, a damping element can be provided in order to reduce kinetic energy, in particular shock energy, of the sliding dog. During the restoring movement, the sliding dog can strike against the damping element, thus reducing the kinetic energy.

In one technical implementation, the dog clutch can have a fixed dog. This is arranged so as to be rotationally fixed and axially fixed in position on the other shaft portion. The sliding dog can be adjusted into a closed position or into an open position by way of an actuator-operated adjusting unit, in particular a sliding sleeve. An overload spring can be supported between the adjusting unit (i.e. the actuator-operated sliding sleeve) and the sliding dog.

Such an arrangement results in the following regular closing operation: The actuator-operated sliding sleeve, through the intermediary of the overload spring, presses the sliding dog in the axial direction, first of all in the closing direction. If the shift dogs of the sliding dog and the fixed dog are situated tooth to gap opposite one another in the axial direction, a smooth positively locking coupling is established. In the more probable case, however, the shift dogs of the sliding dog and of the fixed dog first of all come into tooth to tooth contact during the closing operation. Once the tooth to tooth contact has been achieved, the sliding sleeve is adjusted into its closed position, as a result of which an overload spring force that acts axially on the dogs is built up in the overload spring. As soon as tooth to gap contact has been established as a result of a small relative angular rotation in the case of a small speed difference between the two shaft portions, the two dogs enter into positively locking connection, with the overload spring force being reduced.

In contrast to the above regular closing operation, a fault case is described below, in which the damping element according to an example can be used. In the fault case, in the case of an excessively large speed difference between the shaft portions, the sliding sleeve is incorrectly adjusted into its closed position by the actuator. On account of the excessively large speed difference, there is no smooth positively locking coupling of the dogs. Instead, the sliding dog can be brought only into tooth to tooth contact with the fixed dog. In this case, the spring-loaded sliding dog rebounds off deflection contours of the fixed dog counter to the closing direction. This creates axial dynamics, in which the sliding dog is axially adjusted by the fixed dog deflection contours in a counter-closing direction in a restoring movement and then springs back again in the closing direction into tooth to tooth contact, specifically with a shock being applied to the fixed dog. In order to reduce shock energy, the sliding dog strikes against the damping element in its restoring movement. This reduces kinetic energy (i.e. shock energy) of the sliding dog as the damping element is deformed. This prevents the positively locking coupling from unintentionally closing on account of excessive shock energy of the sliding dog.

By contrast, without the damping element being provided, the sliding dog would spring back into tooth to tooth contact with excessively high shock energy and could unintentionally enter into positively locking coupling with the fixed dog.

In an example, the sliding dog can extend annularly around the outer circumference of the first shaft portion. In this case, the sliding dog, by way of its end face facing away from the dogs, can be brought into abutment with the damping element. For faultless functionality, it is advantageous if the damping element extends annularly around the outer circumference of the first shaft portion and, when viewed in the circumferential direction, can be continuously brought into abutment with the sliding dog.

In an example, the damping element can consist of an elastically and/or plastically deformable damping body. This can be connected to a carrier element, which can be fastened to the first shaft portion. In an example, the damping element can be formed of a rubber material or elastomer material. In an example, the damping element can be a hollow profile element, the hollow chamber of which is filled with damping material, for instance damping gel or damping particles.

### BRIEF DESCRIPTION OF DRAWINGS

The examples of the invention are described below with reference to the appended figures, in which:

FIGS. 1 to 11 each show views, with reference to which a clutch assembly is illustrated.

### DESCRIPTION

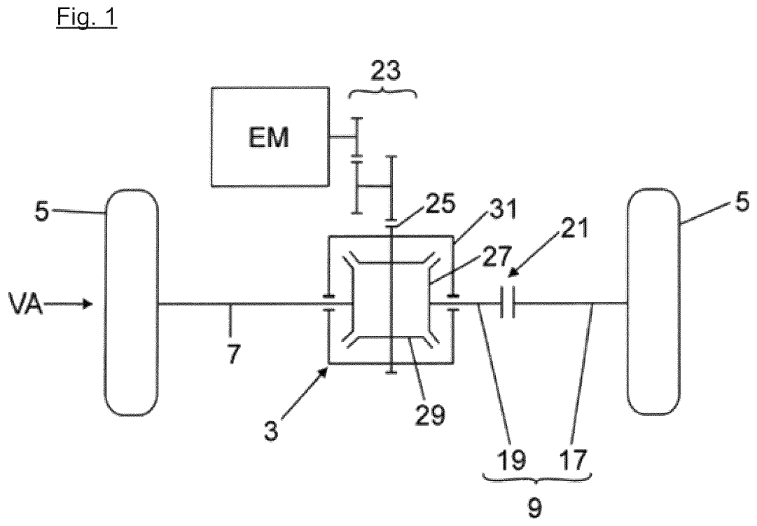

In FIG. 1, by way of example, a dog clutch 21 is installed in an electrically drivable front axle VA of an electrically driven vehicle. The front axle VA is equipped with an electric machine EM, which drives the left and right drive shafts 7, 9 leading to the right and left front wheels 5 via a front-axle differential 3. As is also shown in FIG. 1, the front right drive shaft 9 is divided into a wheel-side shaft portion 17 and an axle-side shaft portion 19. These can be coupled by the dog clutch 21 in order to bring the electric machine EM into drive connection with the vehicle wheels 5 during driving operation. Alternatively, the shaft portions 17, 19 can be uncoupled from one another in order to avoid drag losses during driving operation and when the electric machine EM is deactivated.

Therefore, when the dog clutch 21 is open, only a load-free differential movement of the differential bevel gears 29 in the front-axle differential 3 remains during driving operation. By contrast, the rest of the drive unit (i.e. the transmission and electric machine) comes to a standstill, so that drag losses are greatly reduced.

In FIG. 1, the electric machine EM of the front axle VA is drivingly connected to an input-side external gear 25 of the front-axle differential 3 via a countershaft 23. On the output side of the front-axle differential 3, axle bevel gears 27 are connected to the two drive shafts 7, 9. The axle bevel gears 27 and differential bevel gears 29 that are splined thereto are positioned within a differential housing 31 of the axle differential 3.

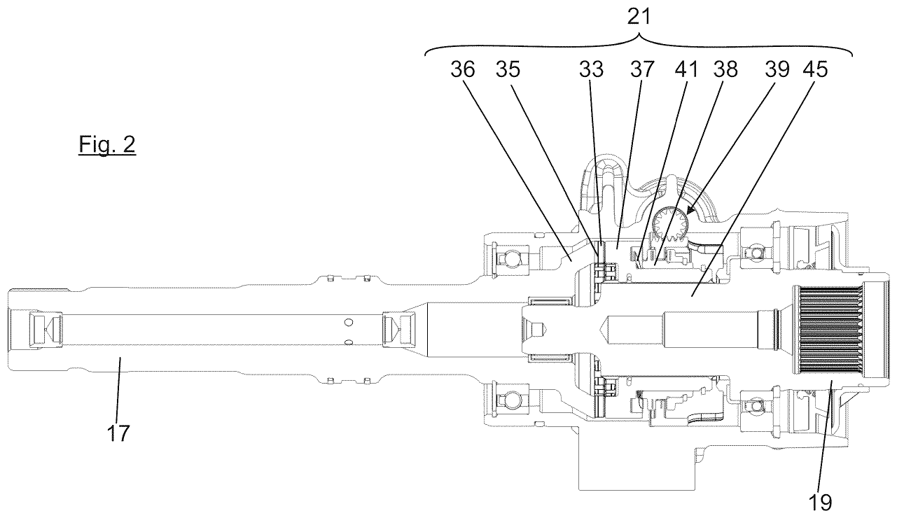

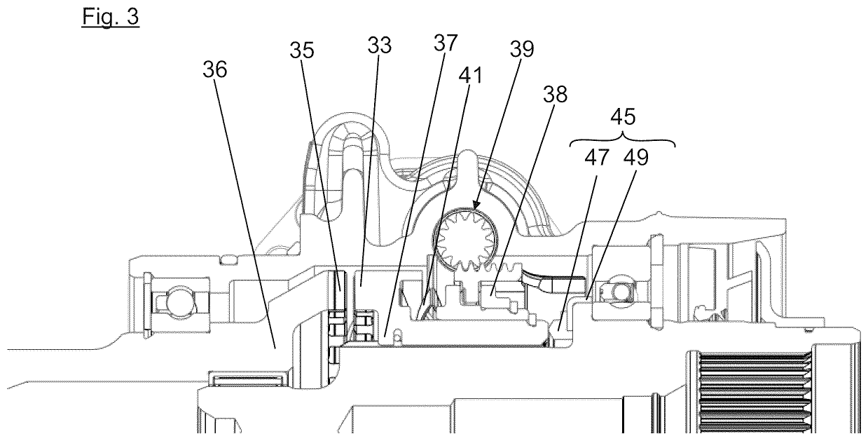

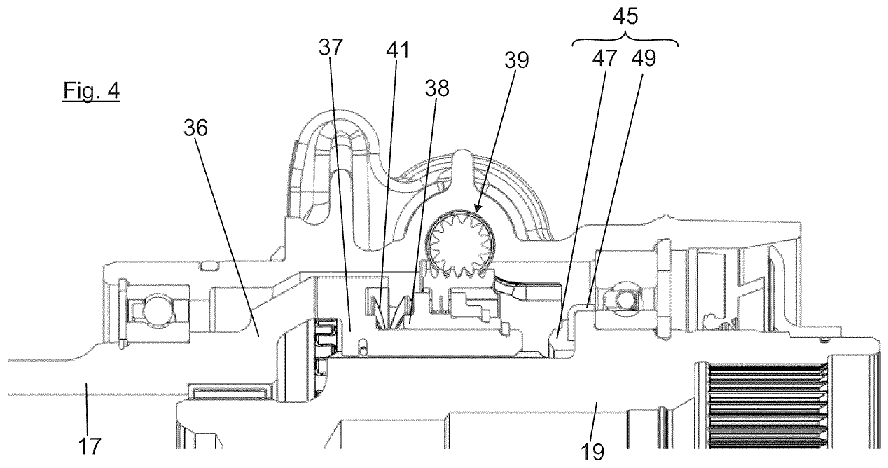

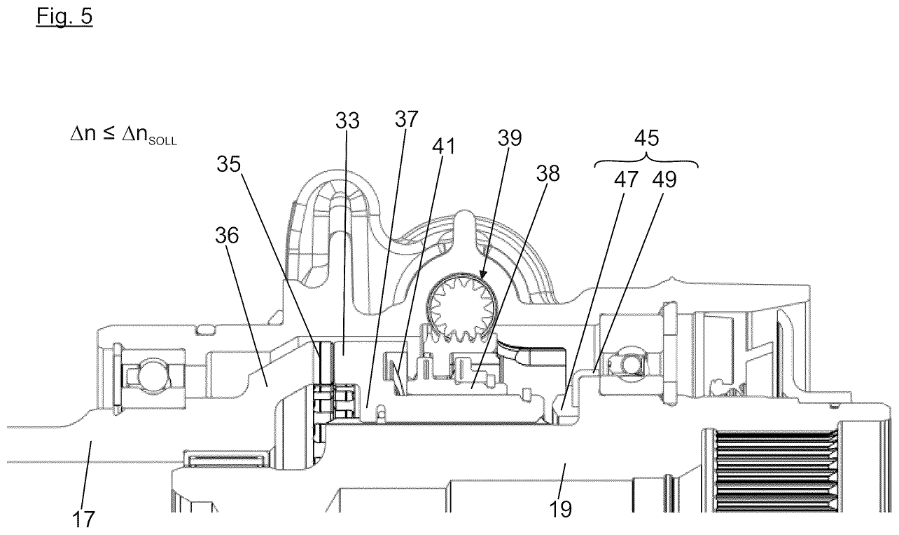

The structure and functioning of the dog clutch 21 will be described below with reference to FIG. 2. Thus, the axle-side shaft portion 19 is connected to the axle bevel gear 27 (not shown in FIG. 2). The axle-side shaft portion 19 is rotationally mounted with its outer shaft end radially within a stub shaft that leads to the front wheel 5 and forms the wheel-side shaft portion 17. In FIG. 2, the dog clutch 21 has axle-side shift dogs 33 and wheel-side shift dogs 35, which are in positively locking connection with one another when the dog clutch 21 is closed. In FIG. 2, the wheel-side shift dogs 35 are part of a fixed dog 36, which is arranged so as to be rotationally fixed and axially fixed in position on the wheel-side shaft portion 17. The axle-side shift dogs 33 are parts of a sliding dog 37, which is arranged so as to be rotationally fixed but axially displaceable on spline toothing of the axle-side shaft portion 19. An annular sliding sleeve 38 is arranged so as to be rotationally fixed but axially adjustable on the outer circumference of the sliding dog 37. The sliding sleeve 38 can be axially adjusted between a closed position (FIGS. 4 and 5) and an open position (FIG. 3) by an actuator 39. According to the figures, an overload spring 41 is supported between the sliding sleeve 38 and the axle-side shift dogs 33 of the sliding dogs 37.

In a fault case, which is described later on, the sliding dog 37, by way of its end face 43 (FIG. 2) facing away from the axle-side shift dogs 33 can be brought into abutment with a damping element 45. The damping element 45 extends annularly around the outer circumference of the axle-side shaft portion 19. In addition, the damping element 45 may be configured in two parts, specifically consisting of a substantially plastically deformable damping body 47 and a carrier element 49, which is a rigid component, to which the damping body 47 is connected. The carrier element 49 is fastened to the axle-side shaft portion 19.

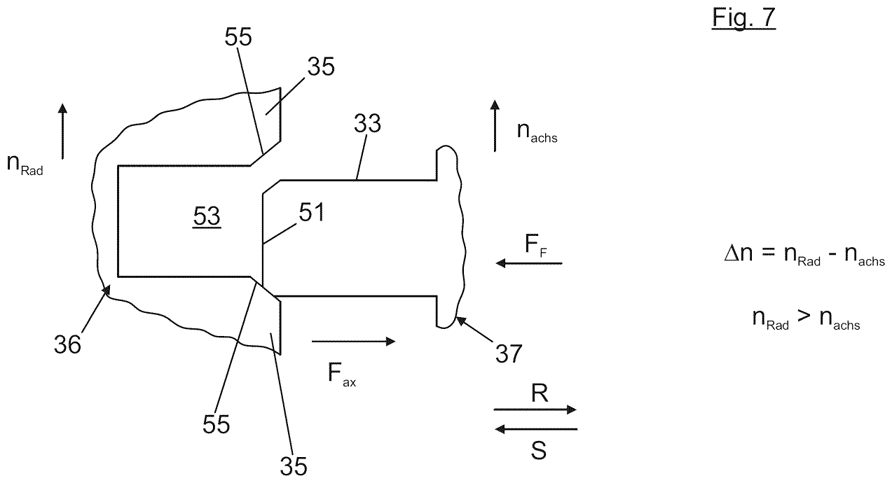

Various operating states of the dog clutch 21 will be described below with reference to FIGS. 3 to 5. In FIG. 3, the actuator-operated sliding sleeve 38 is in its open position, in which the shift dogs 33, 35 are disengaged. In FIG. 4, a coupling operation (i.e. closing operation) of the dog clutch 21 is carried out, in which the wheel-side and axle-side shift dogs 33, 35 are situated tooth 51 to gap 53 axially opposite one another (shown only in FIG. 7). When the actuator 39 is activated, the sliding sleeve 38, together with the sliding dog 37 coupled thereto in terms of movement, is moved from the open position shown in FIG. 4 into the closed position, in which the wheel-side and axle-side shift dogs 33, 35 are smoothly brought into engagement.

In the more probable case—in a departure from FIG. 4—in a regular closing operation, it is possible for the wheel-side and axle-side shift dogs 33, 35 to be situated not tooth 51 to gap 53, but rather tooth 51 to tooth 51, as shown in FIG. 5, axially opposite one another during the closing operation. In this case, during the closing operation, the wheel-side and axle-side shift dogs 33, 35 first of all come into tooth 51 to tooth 51 contact. Once the tooth 51 to tooth 51 contact has been achieved, the actuator 39 further adjusts the sliding sleeve 38 by way of an overload stroke into its closed position, specifically by building up a spring force F_{F} (FIG. 7) of the overload spring 41, which acts on the sliding dog 37. As soon as the tooth 51 is opposite the gap 53 as a result of a small relative angular rotation and in the case of a small speed difference An between the two shaft portions 17, 19, the sliding dog 37 is abruptly brought into positively locking connection with the fixed dog 36 while using up the overload stroke and reducing the spring force FF of the overload spring 41.

The regular closing operation described above with reference to FIG. 5 is carried out under the condition that the speed difference An between the speed n_{Rad} of the wheel-side shaft portion 17 and the speed n_{achs} of the axle-side shaft portion 19 is less than or equal to a setpoint value Δnₛₒₗₗ. This can be 10 rpm, for example.

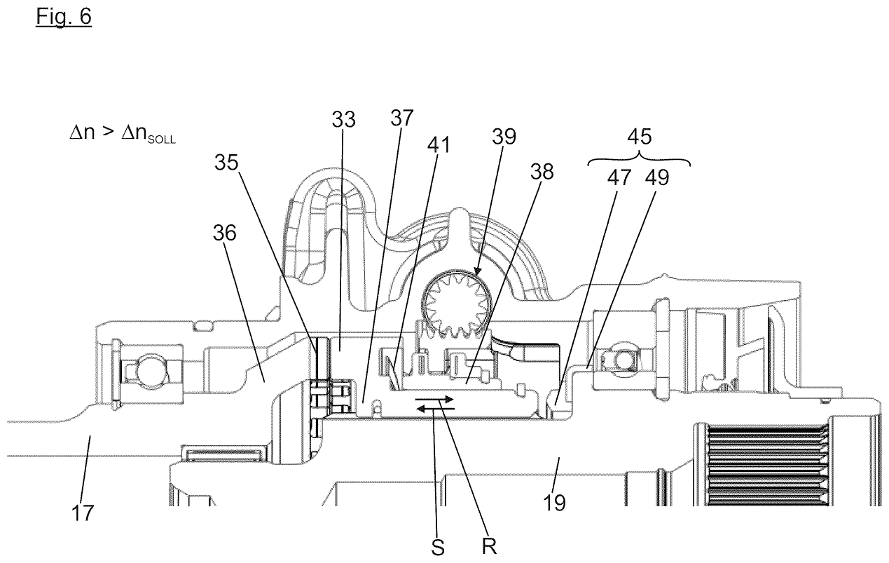

A fault case, in which the damping element 45 according to an example is used, will be described below with reference to FIGS. 5 and 6. In the fault case, in the case of an impermissibly large speed difference, the actuator 39 incorrectly actuates the sliding sleeve 38 into its closed position (i.e. Δn>Δnₛₒₗₗ). On account of the excessively large speed difference An, the shift dogs 33, 35 cannot enter into a positive fit with one another. Instead, the sliding dog 37 rebounds off deflection contours 55 (FIG. 7) of the fixed dog 36.

According to FIG. 7, the deflection contours 55 are inclined leading flanks at the axially outer ends of the dog gaps 53 of the fixed dog 36. In FIG. 7, by way of example, the speed n_{Rad} of the wheel-side shaft portion 17 is greater than the speed n_{achs} of the axle-side shaft portion 19. In the (actually impermissible) closing operation, the shift dog 33 of the sliding dog 37 comes into sliding contact with the inclined leading flank of the deflection contour 55, as a result of which an axial force component Fₐₓ (FIG. 7) acting on the sliding dog 37 is generated. This creates axial dynamics, in which the sliding dog 37 is adjusted in a restoring movement R counter to the closing direction and by building up the spring force F_{F} of the overload spring 41 and then springs back again in the closing direction into tooth 51 to tooth 51 contact (i.e. on the tooth deflection contour 55), specifically with a shock S being applied to the fixed dog 36.

The sliding dog 37 strikes against the damping element 45 in its restoring movement R, so that, as the damping element 45 is plastically deformed, kinetic energy in the sliding dog 37 is reduced. Accordingly, the sliding dog collision S taking place in the closing direction is applied to the fixed dog 36 with reduced shock energy. The dog clutch 21 is therefore prevented from unintentionally closing on account of excessive shock energy of the sliding dog 36.

By contrast, if the damping element 36 were to be omitted, in the above fault case, the sliding dog 37 would collide without damping against the ring shoulder 57 of the axle-side shaft portion 19 and spring back therefrom at a high initial speed in the closing direction with excessive shock energy and with the spring force stored in the overload spring 41 being reduced. The excessively high shock energy would entail the risk of the closing dog 37 overcoming the deflection contours 55 of the fixed dog 36 and of unintentional positively locking coupling occurring between the sliding dog 37 and the fixed dog 36.

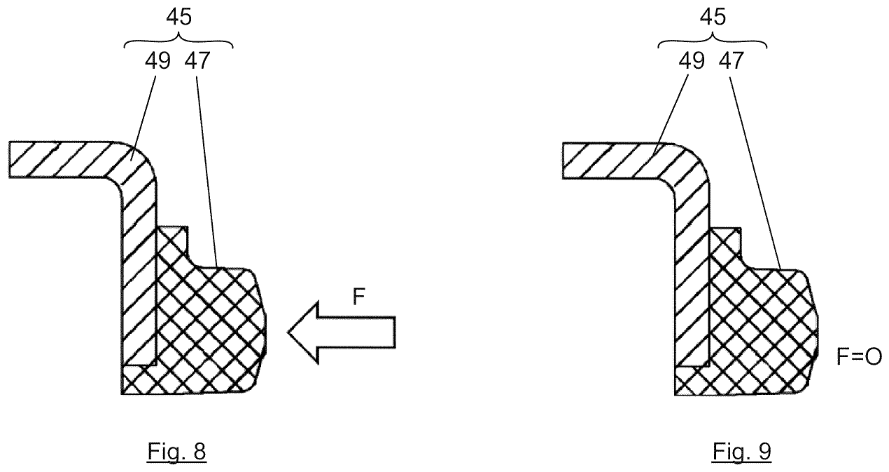

In FIGS. 8 and 9, the damping element 45 is formed according to a first variant embodiment from an annular sheet-metal angle profile as a support element 49. An elastomer material is vulcanized to the sheet-metal angle profile as a damping body 47, which partially returns back to its original shape in an elastically resilient manner after the application of force F (FIG. 8).

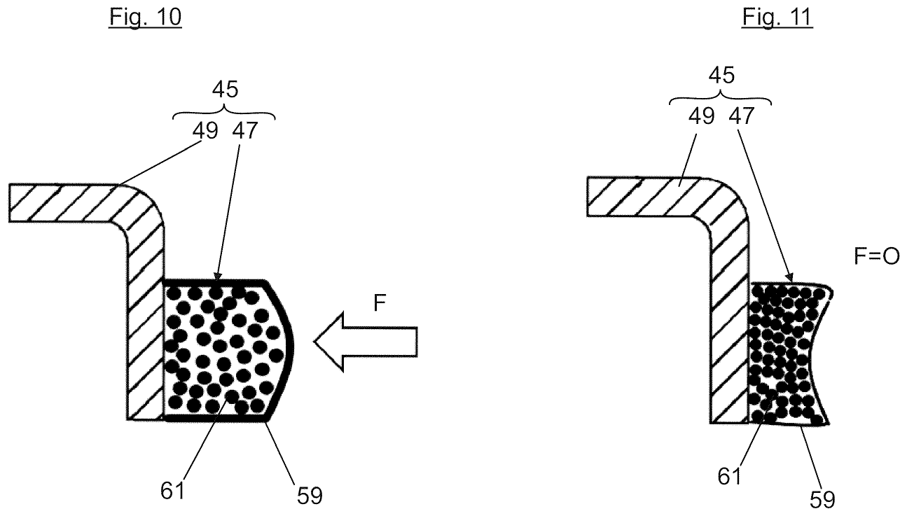

Alternatively thereto, in FIGS. 10 and 11, the damping body 47 has a flexible hollow profile element 59, the hollow chamber of which is filled with damping material 61, for instance damping particles. The damping body 47 formed in this way deforms largely plastically, so that after the application of force F (FIG. 10), the damping body 47 remains in its deformed state (FIG. 11).

### LIST OF REFERENCE SIGNS

3 front-axle differential
5 front wheels
7,9 drive shafts of the front axle
17 wheel-side shaft portion
19 axle-side shaft portion
21 dog clutch
23 countershaft
25 external gear
27 axle bevel gears
29 differential bevel gears
31 differential housing
33 axle-side shift dogs
35 wheel-side shift dogs
36 fixed dog
37 sliding dog
38 sliding sleeve
39 actuator
41 overload spring
43 sliding dog end face
45 damping element
47 damping body
49 carrier element
51 tooth
53 gap
55 deflection contours
57 ring shoulder
59 hollow profile element
61 damping material
Δn speed difference
Δnₛₒₗₗ setpoint value
n_{rad} speed of the wheel-side shaft portion 17
n_{achs} speed of the axle-side shaft portion 19
R restoring movement
S shock
Fₐₓ axial force component
F_{F} spring force

1-9. (canceled)

10. A clutch assembly, comprising:
two shaft portions couplable by a dog clutch, which has a sliding dog arranged so as to be rotationally fixed but axially displaceable on a first shaft portion of the two shaft portions, in an operating state, including in a fault state, the sliding dog is adjustable to counter to a closing direction for a closed position in a restoring movement (R);
a damping element, against which the sliding dog strikes during the restoring movement (R), reduces kinetic energy, including shock energy,
the damping element is a plastically deformable damping body, which is connected to a carrier element fastened to the first shaft portion, so that the shock energy of the sliding dog is reduced as the damping element is plastically deformed, and so that, in the fault state, the dog clutch is prevented from unintentionally closing on account of excessive shock energy of the sliding dog.

11. The clutch assembly as claimed in claim 10, wherein the dog clutch has a fixed dog arranged to be rotationally fixed and axially fixed in position on a second shaft portion of the two shaft portions,
so that the sliding dog is adjustable into the closed position or into an open position by an actuator-operated sliding sleeve, and an overload spring is supportable between the actuator-operated sliding sleeve and the sliding dog,
so that in a regular closing operation, the actuator-operated sliding sleeve, through an intermediary of the overload spring, is configured to bring the sliding dog in an axial direction into tooth to tooth contact with the fixed dog, and, once the tooth to tooth contact has been achieved, the actuator-operated sliding sleeve is further adjustable into the closed position, by building up an overload spring force (F_{F}) of the overload spring that acts axially on the fixed dog and the sliding dog,
so that, as soon as a tooth to gap contact has been established in a small speed difference (Δn≤Δnₛₒₗₗ) between the two shaft portions, the fixed dog and the sliding dog enter into a positively locking connection, with the overload spring force (F_{F}) of the overload spring (41) being reduced, and
so that in the fault state, in case of an excessively large speed difference (Δn≤Δnₛₒₗₗ) between the two shaft portions, and the actuator-operated sliding sleeve is incorrectly adjusted into the closed position, while the sliding dog is brought into the tooth to tooth contact with the fixed dog, which results in creation of axial dynamics, the sliding dog rebounds off deflection contours of the fixed dog and is axially adjustable in a counter-closing direction in the restoring movement (R) and then springs back again in the closing direction into the tooth to tooth contact, with a shock(S) being applied to the fixed dog.

12. The clutch assembly as claimed in claim 10, wherein the sliding dog extends annularly around an outer circumference of the first shaft portion, and/or the sliding dog, by way of an end face of the sliding dog facing away from axle-side shift dogs and wheel-side shift dogs, is brought into abutment with the damping element.

13. The clutch assembly as claimed in claim 10, wherein the damping element extends annularly around an outer circumference of the first shaft portion.

14. The clutch assembly as claimed in claim 10, wherein the damping element has a flexible hollow profile element, a hollow chamber of which hollow profile element is filled with at least one damping material from among a damping gel and damping particles.
